(19) United States
(12) Patent Application Publication
(10) Pub. No.: US 2008/0090121 A1
(43) Pub. Date: Apr. 17, 2008

(54) HYDROGEN STORAGE MATERIALS, APPARATUS AND SYSTEMS

(75) Inventor: JI-CHENG ZHAO, LATHAM, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/548,710

(22) Filed: Oct. 12, 2006

(51) Int. Cl. H01M 8/04; B65D 85/00; C22C 21/00

(52) U.S. Cl. 429/24; 206/7; 420/528

(57) ABSTRACT

An apparatus, method, and material for storing and retrieving hydrogen are disclosed. The apparatus comprises a storage component, and this component comprises a hydrogen storage medium. The hydrogen storage medium comprises an aluminoborane hydride AlBₓHₙ wherein x is equal to or greater than 4 and n is equal to or greater than 10. The method for storing and retrieving hydrogen comprises providing a source of hydrogen; providing a storage component, the component comprising a hydrogen storage medium, wherein the hydrogen storage medium comprises boron and aluminum in a molar ratio equal to or greater than 4 and at least one catalyst; and exposing the medium to hydrogen from the source. The material comprises an aluminoborane hydride AlBₓHₙ wherein x is equal to or greater than 4 and n is equal to or greater than 10 and at least one catalyst selected from hydrides, fluorides, chlorides, oxides, elements and alloys and combination thereof.

### BACKGROUND

This invention relates generally to the storage of hydrogen and more particularly to hydrogen storage materials, apparatus and systems.

Hydrogen is sometimes referred to as a “clean fuel” because it can be reacted with oxygen in hydrogen-consuming devices, such as a fuel cell or a combustion engine, to produce energy and water. Virtually no other reaction byproducts are produced in the exhaust. As a result, the use of hydrogen as a fuel effectively solves many environmental problems associated with the use of petroleum based fuels. Safe and efficient storage of hydrogen gas is, however, essential for many applications that can use hydrogen. In particular, minimizing the volume and weight of hydrogen storage systems are important factors in mobile applications.

Several methods of storing hydrogen are currently used or contemplated but these are either inadequate or impractical for widespread mobile consumer applications. For example, hydrogen can be stored in liquid form at very low temperatures. However, the energy consumed in liquefying hydrogen gas is about 30% of the energy available from the resulting hydrogen. In addition, a standard tank filled with liquid hydrogen will become empty in about a week through evaporation; thus dormancy is also a problem. Moreover, the volume required to store 5 kilograms of liquefied hydrogen to enable a travel distance of about 300 miles in a passenger car would require more than twice the space of the equivalent gasoline tank. These factors make liquid hydrogen impractical for most consumer applications.

An alternative is to store hydrogen under high pressure. As an example, however, a 100 pound steel cylinder can only store about one pound of hydrogen at about 2200 psi, which translates into about 1% by weight of hydrogen storage. More expensive composite cylinders can store hydrogen at higher pressures of about 10,000 psi (about 690 atmospheric pressure) to achieve a more favorable storage ratio of about 5% by weight. The high pressure, however, raises safety concerns amongst consumers. Similar to liquefied hydrogen, the volume required to store 5 kilograms of compressed hydrogen to enable a travel distance of about 300 miles in a passenger car would require more than twice the space of the equivalent gasoline tank. These factors have led to a search for alternative hydrogen storage technologies that are both safe and efficient.

Another technology, metal hydride storage systems, has good volumetric storage density when compared to liquefied and compressed hydrogen systems. Good volumetric storage density is especially important for on-board vehicular storage because it would allow adequate hydrogen storage without taking up valuable space on the vehicle. Several metal hydrides are available commercially, representing a good solution for hydrogen storage where weight is not a significant problem, for example on buses. For most vehicles, however, the problem with metal hydride storage is the high weight of the material compared to the amount of hydrogen that is stored. The problem of weight has still not been solved in spite of extensive research.

Work is being done to find high-capacity hydrides that have the ability to absorb and desorb large amounts of hydrogen and at the same time release the hydrogen at a relatively low temperature. The International Energy Agency's (IEA) metal hydride program has a goal of developing a material that has a reversible storage capacity of 5 weight percent absorbed hydrogen and hydrogen release at less than 100° C., within the next few years. The Department of Energy (DOE) has goals of developing a hydrogen storage system that has reversible storage capacity of 6 weight percent absorbed hydrogen and hydrogen release at less than 100° C. by 2010 and 9 weight percent by 2015, still considered to be extremely aggressive targets. The DOE target of 6 and 9 weight percent systems would require hydrides of at least 9 and 13.5 weight percent respectively, since at least a third of the weight goes to the balance of plant (the storage tank and heat exchange components).

Today's proton exchange membrane (PEM) fuel cells operate at relatively low temperatures, typically at about 80° C. Typically, the excess heat from the fuel cell is used to release the hydrogen from the metal hydride storage tank. Accordingly, it is widely assumed that the most practical applications would require the metal hydride storage tank to release hydrogen at about the same temperature that the fuel cell operates at, for example with PEM fuel cells, this temperature range would be from about 60° C. to about 100° C. This temperature calls for high-capacity hydrides that can be desorbed at low temperatures. The state-of-the-art metal hydrides are represented by Ti-catalyzed NaAlH₄ that can provide reversible storage of about 3.5 wt. % hydrogen at about 100° C. Existing higher weight percent reversible hydrogen storage materials require much higher temperatures for absorption and desorption. For instance, a mixture of 2LiBH₄ and MgH₂ can reversibly store about 10 weight percent hydrogen to become a mixture of MgB₂ and 2LiH; but it requires about 400° C. to achieve the 10 weight percent reversibility. The temperature is much beyond the exhaust temperature of the PEM fuel cells.

In view of the above, there is a need for higher capacity metal hydrides that can desorb hydrogen at low temperatures, especially for on-board vehicular applications. There is also a need for an improved fuel cell system that enables utilization of metal hydride storage tanks with higher hydrogen storage capacities without requiring independent heat generation to raise the temperature to release the hydrogen from the metal hydride storage tanks.

### BRIEF DESCRIPTION

These and other needs are addressed by embodiments of the present invention. One embodiment is a hydrogen storage material comprising an aluminoborane hydride AlBₓHₙ wherein x is equal to or greater than 4 and n is equal to or greater than 10. Examples of aluminoborane hydride AlBₓHₙ are AlB₄H₁₁, AlB₅H₁₂, AlB₅H₁₆, AlB₆H₁₃, AlB₇H₂₀, AlB₉H₂₄, and combination thereof. Another embodiment is a hydrogen storage material comprising an aluminoborane hydride AlBₓHₙ wherein x is equal to or greater than 4 and n is equal to or greater than 10 and at least one catalyst selected from hydrides, fluorides, chlorides, oxides, elements and alloys and combination thereof. Yet another embodiment is a hydrogen storage and delivery system comprising a storage tank and a hydrogen storage material; the hydrogen storage material comprises an aluminoborane hydride AlBₓHₙ wherein x is equal to or greater than 4 and n is equal to or greater than 10. Yet another embodiment of the present invention is a fuel cell system that comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and for catalytically reacting the anode exhaust to produce an offgas having an elevated temperature that is greater than the temperature of the anode exhaust. The heat from the offgas is used to release the hydrogen from the hydrogen storage system. The hydrogen storage system comprises a hydrogen storage material comprising an aluminoborane hydride AlBₓHₙ wherein x is equal to or greater than 4 and n is equal to or greater than 10.

### BRIEF DESCRIPTION OF THE DRAWINGS

FIG. 1 is a depiction of a hydrogen storage and delivery system.

FIG. 2 is a depiction of a fuel cell system according to embodiments of the present invention, including a hydrogen storage system.

FIG. 3 is a schematic illustration of a hydrogen-powered system which comprises a hydrogen storage system, along with an ICE engine or other hydrogen consuming device.

FIG. 4 illustrates an exemplary apparatus for storing hydrogen, according to the present invention.

### DETAILED DESCRIPTION

Several different metal hydrides have been extensively studied as potential solid-state storage media for hydrogen fuel systems. However, these materials thus far have proven to have only limited potential due to a relatively low gravimetric capacity for storage of recoverable hydrogen. For example, most hydrides are able to store up to about 2 weight percent of hydrogen, with certain high-potential materials, for example, sodium alanate (NaAlH₄), potentially storing up to about 4 weight percent hydrogen at about 100° C. Even the high-potential materials fall short of the U.S. Department of Energy's stated goals of a hydrogen storage system that has a reversible storage capacity of 6 weight percent absorbed hydrogen and hydrogen release at less than 100° C. by 2010 and 9 weight percent by 2015. The DOE targets of 6 and 9 weight percent systems would require hydrides of at least 9 and 13.5 weight percent since at least a third of the weight goes to the balance of plant (the storage tank and heat exchange components). All the metal hydrides currently studied as hydrogen storage materials fall far short of these goals in terms of high weight percent capacity and low desorption temperatures. The most desired metal hydrides would be those with a gravimetric capacity greater than 9 weight percent and most preferably greater than 13.5 weight percent and a desorption temperature lower than 100° C. The desorption temperature is very critical and is thought to be dictated by the exhaust temperature of the PEM fuel cells and is widely thought to be less than 120° C. and more practically less than 100° C. Above 100° C., the superheated steam in the PEM fuel cells would likely significantly degrade the fuel cell life.

Embodiments of the present invention are based on a series of aluminoborane hydrides in the form of AlBₓHₙ wherein x is equal to or greater than 4 and n is equal to or greater than 10. Examples of this series of aluminoborane hydrides include AlB₄H₁₁, AlB₅H₁₂, and AlB₆H₁₃ that were first synthesized by Francis L. Himpsl Jr. and Arthur C. Bond and published in the Journal of the American Chemical Society, volume 103, pages 1098-1102 in 1981. These aluminoborane hydrides have a hydrogen capacity of 13.5, 12.9 and 12.4 weight percent respectively. They are unique in their surprising high thermal stability: they are stable up to 100-140° C. which is significantly higher than the standard aluminum borohydride Al(BH₄)₃ (it can be written as AlB₃H₁₂). Al(BH₄)₃ has a melting point around −64.5° C. and a boiling point about 44.5° C. according to H. I. Schlesinger, R. T. Sanderson, and A. B. Burg in a paper published in Journal of the American Chemical Society, volume 62, pages 3421-3425 in 1940. Al(BH₄)₃ slowly decomposes even at ambient temperature. Al(BH₄)₃ is an extremely hazardous material since its vapor ignites spontaneously on exposure to air containing only traces of moisture. Therefore, Al(BH₄)₃ is unsuitable for hydrogen storage for on-board vehicular applications. It is contemplated by the present invention that aluminoborane hydrides AlB₄H₁₁, AlB₅H₁₂, and AlB₆H₁₃ are desirable as a hydrogen storage material due to the high weight percent capacity, good stability temperature and potential reversibility with a catalyst.

The aluminoborane hydrides AlB₄H₁₁, AlB₅H₁₂, and AlB₆H₁₃ usually exist in the form of amorphous materials with little distinctive x-ray diffraction peaks. Infrared (IR) spectra, however, reveal distinctive features for the identification of these materials. The aluminoborane hydride AlB₄H₁₁ exhibits the following principal absorption bands (in cm⁻¹): 2530 (vs), 2458 (s), 2380 (s), 2350 (s), 2275 (vs), 2100 (m), 2050 (m), 1150 (m), 1050 (w), 990 (m), 935 (m), 910 (m), 850 (w), and 800 (w); where (vs), (s), (m), and (w) refer to very strong, strong, medium, and weak, respectively. The aluminoborane hydride AlB₅H₁₂ exhibits the following principal absorption bands (in cm⁻¹): 2530 (s), 2460 (s), 2350 (m), 2270 (m), 2090 (m), 2030 (m), 1148 (m), 1040 (w), 990 (m), 900 (w), 850 (w), and 800 (w). The aluminoborane hydride AlB₆H₁₃ exhibits the following principal absorption bands (in cm⁻¹): 2520 (s), 2450 (w), 2370 (m), 2355 (m), 2260 (s), 2100 (m), 1145 (m), 1040 (w), 970 (m), 925 (m), 910 (w), and 840 (w).

Other examples of this series of aluminoborane hydrides AlBₓHₙ include AlB₅H₁₆, AlB₇H₂₀, and AlB₉H₂₄. They can be written as Al(BH₄)₂(B₃H₈), Al(BH₄)(B₃H₈)₂, and Al(B₃H₈)₃. They have a hydrogen capacity of 16.5, 16.3, and 16.2 weight percent, respectively. These hydrides also have thermal stability significantly higher than standard aluminum borohydride Al(BH₄)₃. For instance, AlB₉H₂₄ is a non-volatile, colorless glass-like material. These aluminoborane hydrides are also contemplated as attractive as hydrogen storage materials by the present invention, especially in conjunction with a catalyst.

Accordingly, one embodiment of the present invention is a hydrogen storage material comprising an aluminoborane hydride AlBₓHₙ wherein x is equal to or greater than 4 and n is equal to or greater than 10. Examples of aluminoborane hydride AlBₓHₙ comprise AlB₄H₁₁, AlB₅H₁₂, AlB₅H₁₆, AlB₆H₁₃, AlB₇H₂₀, AlB₉H₂₄, and combinations thereof. These hydrides have good thermal stability and high weight percent hydrogen capacity to be desirable as hydrogen storage materials.

Another embodiment is a hydrogen storage material comprising an aluminoborane hydride AlBₓHₙ wherein x is equal to or greater than 4 and n is equal to or greater than 10 and at least one catalyst. The catalyst is selected from hydrides, fluorides, chlorides, oxides, elements and alloys and combinations thereof. The hydride catalyst is selected from a group consisting of LiH, NaH, MgH₂, KH, CaH₂, LiAlH₄, NaAlH₄, Mg(AlH₄)₂, KAlH₄, Ca(AlH₄)₂, TiH₂, VH₂, and combinations thereof. The catalyst of fluorides and chlorides are selected from the fluorides and chlorides of Li, Na, Mg, K, Ca, and transition metals. In one embodiment, the fluoride catalyst is selected from TiF₃, FeF₂, FeF₃, CuF₂, RuF₃, RhF₃ and ZrF₄, and combinations thereof. In one embodiment, the chloride catalyst is selected from TiCl₃, FeCl₂, FeCl₃, CuCl₂, RuCl₃, RhCl₃, and ZrCl₄, and combinations thereof. The oxide catalyst is selected from the group of Al₂O₃, SiO₂, SnO, and transition metal oxides. In one embodiment, the oxide catalyst is Al₂O₃, SiO₂, and Nb₂O₅ and combinations thereof. In another embodiment, the element and alloy catalyst is selected from carbon and transition metals and their alloys and borides. In another embodiment, the element and alloy catalyst is selected from the group consisting of Pd, Pt, Rh, Ru, La, Ni, carbon, Fe, Co, Cu, Ti, Re, LaNi₅, FeTi, NiB, NiB₂, and combinations thereof. Catalyst mixtures are highly desired to have the best kinetics in hydriding and dehydriding. For instance, TiCl₃ and TiF₃ are known to be effective catalysts for Al reaction with hydrogen and NaH. NaH, LiH and CaH₂ are known to be effective in reducing the surface oxide of Al to make it more reactive. Other catalysts such as Rh on Al₂O₃, Pt on Al₂O₃, Rh on carbon, Pd on carbon, NiB, and NiB₂ are conventionally used to improve the boron reactivity and transfer. Mixtures of these catalysts are contemplated to be effective in improving the kinetics of the hydriding and dehydriding reactions.

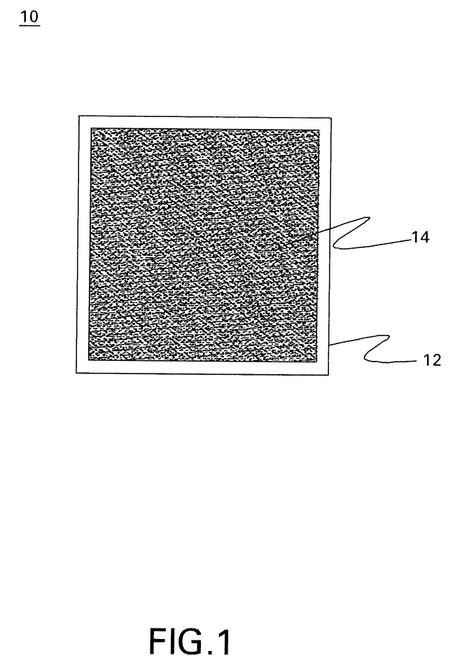

Yet another embodiment of the present invention is a hydrogen storage and delivery system 10 comprising a storage tank 12 and a hydrogen storage material 14; the hydrogen storage material 14 comprises an aluminoborane hydride AlBₓHₙ wherein x is equal to or greater than 4 and n is equal to or greater than 10, as shown in FIG. 1. Such a hydrogen storage and delivery system 10 is suitable for on-board vehicular applications, especially for PEM-fuel cell powered automobiles, internal combustion engine (ICE) powered automobiles, off-road vehicles, and other vehicles that may be powered with hydrogen.

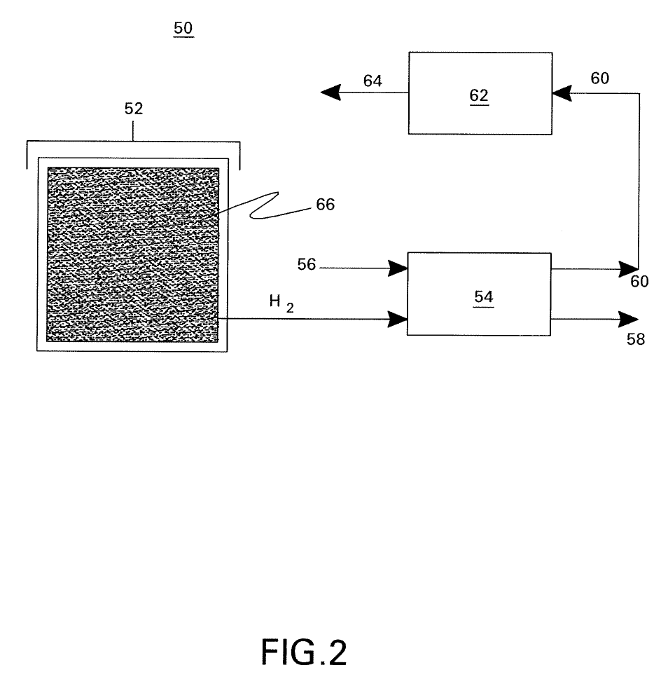

Yet another embodiment of the present invention is a fuel cell system 50 comprising a hydrogen storage system 52 for storing and releasing hydrogen, a fuel cell 54 in fluid communication with the hydrogen storage system 52 for receiving released hydrogen from the hydrogen storage system 52 and for electrochemically reacting the hydrogen with an oxidant 56 to produce electricity 58 and an anode exhaust 60, as shown in FIG. 2. A catalytic combustor 62 is in fluid communication with the fuel cell 54 for receiving the anode exhaust 60 and for catalytically reacting the anode exhaust 60 to produce an offgas 64 having an elevated temperature that is greater than the temperature of the anode exhaust 60. The heat from the offgas 64 is used to release the hydrogen from the hydrogen storage system 52. The hydrogen storage system 52 comprises a hydrogen storage material 66 comprising an aluminoborane hydride AlBₓHₙ wherein x is equal to or greater than 4 and n is equal to or greater than 10. Since the hydrogen utilization efficiency within a fuel cell, for example a PEM fuel cell, is never a hundred percent, there is always a small amount of residual hydrogen in the fuel cell exhaust. In this embodiment, the residual hydrogen in the exhaust 60 of the fuel cell 54 is catalytically combusted to raise the temperature of the offgas 64 from the fuel cell 54 to facilitate the desorption of hydrogen from the high capacity hydrogen storage material 66 aluminoborane hydride AlBₓHₙ wherein x is equal to or greater than 4 and n is equal to or greater than 10. In one embodiment, the temperature of the offgas is in the range between about 100 C to about 500 C.

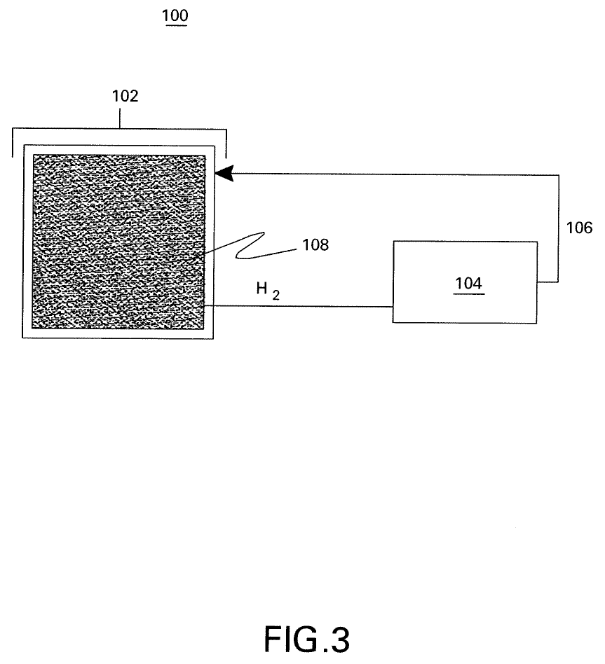

Yet another embodiment of the present invention is a hydrogen-powered system 100 that comprises a hydrogen storage system 102 for storing and releasing hydrogen, an ICE engine or other hydrogen-consuming device 104 in fluid communication with the hydrogen storage system 102 for receiving released hydrogen from the hydrogen storage system 102, as shown in FIG. 3. The heat from the offgas 106 of the ICE or other hydrogen-consuming device 104 is used to release the hydrogen from the hydrogen storage system 102. The hydrogen storage system 102 comprises a hydrogen storage material 108 comprising an aluminoborane hydride AlBₓHₙ wherein x is equal to or greater than 4 and n is equal to or greater than 10.

In some embodiments, the aluminoborane hydride AlBₓHₙ is decomposed or dehydrogenated to aluminum and boron and hydrogen is delivered to the hydrogen-consuming device 104 to generate energy. The process may produce a small amount of borane or diborane. In this case, it is an optional embodiment to pass the desorbed gas through a membrane or another medium (not shown) to remove the borane or diborane, thus providing high-purity hydrogen to the hydrogen-consuming device 104. This is particularly important to PEM fuel cells for which borane or diborane may be detrimental to PEM fuel cell performance.

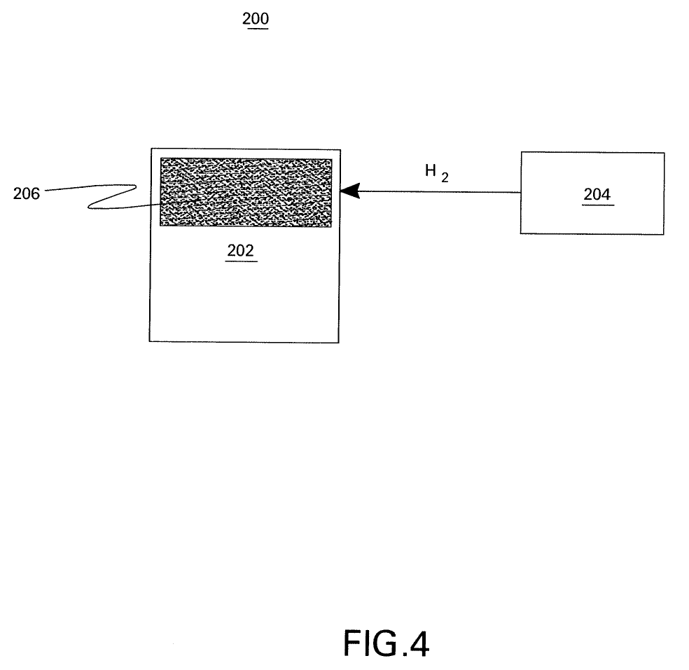

One embodiment of the present invention is an apparatus for storing hydrogen 200, as shown in FIG. 4. The apparatus 200 comprises a storage component 202 such as, for example, a tank or some other suitable container adapted to receive hydrogen from a hydrogen source 204. The storage component 202 comprises a hydrogen storage medium 206, and this medium 206 comprises boron and aluminum in the molar ratio greater than four and at least one catalyst; the catalyst is selected from hydrides, fluorides, chlorides, oxides, elements and alloys and combination thereof. When fully charged with hydrogen the medium 206 comprises an aluminoborane hydride AlBₓHₙ wherein x is equal to or greater than 4 and n is equal to or greater than 10. The aluminoborane hydride AlBₓHₙ includes AlB₄H₁₁, AlB₅H₁₂, AlB₅H₁₆, AlB₆H₁₃, AlB₇H₂₀, AlB₉H₂₄, and combination thereof.

In an exemplary, practical application of the hydrogen storage apparatus of the present invention, hydrogen is supplied from a source, such as a tank of hydrogen or a hydrogen production apparatus such as an electrolysis cell or hydrocarbon gas reformer, and then introduced into the storage component, where the storage medium is disposed within the storage component. In one example, the medium comprises a solid material, and in particular embodiments is a granular or powder material disposed within the storage component. Regardless of the form of the medium or where it is disposed, the hydrogen is exposed to the storage medium, whereupon the hydrogen reacts with the storage medium to form an aluminoborane hydride AlBₓHₙ wherein x is equal to or greater than 4 and n is equal to or greater than 10. When hydrogen gas is required to be supplied, the storage medium is heated to decompose the hydride, and the resultant hydrogen gas is transported to an end use system or stored.

In addition to the addition of a hydrogen absorption/desorption catalyst to the aluminoborane hydride AlBₓHₙ, to improve the kinetics, dopants may be contemplated to be added to the AlBₓHₙ to replace Al to reduce the hydrogen desorption temperature and to improve the kinetics. Examples of such dopants include elements such as titanium, vanadium, chromium, zirconium, niobium, yttrium, lanthanum, manganese, nickel, iron, cobalt, silicon, copper, zinc and mixtures of any of the foregoing elements. The amount of dopants added into the AlBₓHₙ depends in part upon the identity of the dopant and the composition of the AlBₓHₙ. In certain embodiments the dopant is present in an amount of up to about 20 mole percent replacing aluminum (the 20 mole percent is based on aluminum content only), such as, for example, from about 0.5 mole percent to about 10 mole percent.

Embodiments of the present invention also include a method for storing and retrieving hydrogen. The method comprises providing a source of hydrogen; providing a storage component adapted to receive hydrogen from the source, the component comprising a hydrogen storage medium, wherein the hydrogen storage medium comprises boron and aluminum in a ratio equal to or greater than four and optionally at least one catalyst; and exposing the medium to hydrogen from the source. Upon exposure, the medium reacts with the hydrogen to form an aluminoborane hydride AlBₓHₙ wherein x is equal to or greater than 4 and n is equal to or greater than 10, as described previously. Suitable alternatives for the source of hydrogen, the storage component, and the storage medium include those described above for the storage apparatus embodiments. The method, in some embodiments, further comprises heating the hydrogen storage medium to a hydrogen retrieval temperature, for example, typically greater than 100 C and often between 100 C and 500 C. Doing this will desorb hydrogen that is stored in the aluminoborane hydride AlBₓHₙ, and, if the temperature is sufficiently high, will decompose the hydrides back to the original hydrogen storage medium material and hydrogen gas. The ability of the AlBₓHₙ-bearing hydrogen storage medium to decompose to provide hydrogen potentially allows application of embodiments of the present invention in a number of useful areas, including, for example, on-board fuel storage for automobiles; fuel cells, including PEM fuel cells; and internal combustion engine powered automobiles.

Another embodiment of the present invention is the composition of matter that corresponds to certain aspects of the hydrogen storage medium described above. The material comprises an aluminoborane hydride AlBₓHₙ wherein x is equal to or greater than 4 and n is equal to or greater than 10 and at least one catalyst. Particular embodiments of the material of the present invention include a material comprising an aluminoborane hydride AlBₓHₙ wherein x is equal to or greater than 4 and n is equal to or greater than 10; up to about 10 mole percent of a hydrogen absorption/desorption catalyst, such as, for example, from about 0.1 mole percent to about 10 mole percent of the catalyst; up to about 20 mole percent of a dopant to replace aluminum, such as, for example, from about 0 mole percent to about 20 mole percent of the dopant.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An apparatus for storing and delivering hydrogen, comprising:
a storage component, the component further comprising a hydrogen storage medium;
wherein the hydrogen storage medium comprises an aluminoborane hydride AlBₓHₙ wherein x is equal to or greater than 4 and n is equal to or greater than 10.

2. The apparatus of claim 1, wherein aluminoborane hydride AlBₓHₙ is selected from the group consisting of AlB₄H₁₁, AlB₅H₁₂, AlB₅H₁₆, AlB₆H₁₃, AlB₇H₂₀, AlB₉H₂₄, and combinations thereof.

3. The apparatus of claim 2, wherein aluminoborane hydride is AlB₄H₁₁ with an amorphous structure and with the following principal infrared absorption bands (in cm⁻¹): 2530 (vs), 2458 (s), 2380 (s), 2350 (s), 2275 (vs), 2100 (m), 2050 (m), 1150 (m), 1050 (w), 990 (m), 935 (m), 910 (m), 850 (w), and 800 (w).

4. The apparatus of claim 2, wherein the aluminoborane hydride is AlB₅H₁₂ with an amorphous structure and with the following principal infrared absorption bands (in cm⁻¹): 2530 (s), 2460 (s), 2350 (m), 2270 (m), 2090 (m), 2030 (m), 1148 (m), 1040 (w), 990 (m), 900 (w), 850 (w), and 800 (w).

5. The apparatus of claim 2, wherein the aluminoborane hydride is AlB₆H₁₃ with an amorphous structure and with the following principal infrared absorption bands (in cm⁻¹): 2520 (s), 2450 (w), 2370 (m), 2355 (m), 2260 (s), 2100 (m), 1145 (m), 1040 (w), 970 (m), 925 (m), 910 (w), and 840 (w).

6. The apparatus of claim 1, wherein the hydrogen storage medium further comprises at least one catalyst.

7. The apparatus of claim 6, wherein the catalyst is selected from the group consisting of hydrides, fluorides, chlorides, oxides, elements and alloys and combinations thereof.

8. The apparatus of claim 7, wherein:
the hydride catalyst is selected from a group consisting of LiH, NaH, MgH₂, KH, CaH₂, LiAlH₄, NaAlH₄, Mg(AlH₄)₂, KAlH₄, Ca(AlH₄)₂, TiH₂, VH₂, and combinations thereof.

9. The apparatus of claim 7, wherein:
the fluoride catalyst and chloride catalyst are selected from the fluorides and chlorides of Li, Na, Mg, K, Ca, transition metals and combinations thereof.

10. The apparatus of claim 7, wherein:
the fluoride catalyst is selected from the group of TiF₃, FeF₂, FeF₃, CuF₂, RuF₃, RhF₃ and ZrF₄ and combinations thereof.

11. The apparatus of claim 7, wherein:
the chloride catalyst is selected from the group consisting of TiCl₃, FeCl₂, FeCl₃, CuCl₂, RuCl₃, RhCl₃, ZrCl₄ and combinations thereof.

12. The apparatus of claim 7, wherein:
the oxide catalyst is selected from the group consisting of Al₂O₃, SiO₂, Nb₂O₅, SnO, transition metal oxides and combinations thereof.

13. The apparatus of claim 7, wherein:
the element and alloy catalysts are selected from carbon and transition metals and their alloys and borides.

14. The apparatus of claim 7, wherein:
the element and alloy catalysts are selected from the group consisting of Pd, Pt, Rh, Ru, La, Ni, carbon, Fe, Co, Cu, Ti, Re, LaNi₅, FeTi, NiB, NiB₂ and combinations thereof.

15. The apparatus of claim 6, wherein the catalyst is present in an amount of about 0.1 mole percent to about 10 mole percent.

16. The apparatus of claim 1, wherein a dopant is present in the aluminoborane hydride AlBₓHₙ to replace Al.

17. The apparatus of claim 10, wherein the dopant is selected from the group consisting of titanium, vanadium, chromium, zirconium, niobium, yttrium, lanthanum, manganese, nickel, iron, cobalt, silicon, copper, zinc and combinations thereof.

18. The apparatus of claim 10, wherein the dopant is present in the amount from about 0 to about 20 mole percent to replace Al in AlBₓHₙ.

19. An apparatus for storing hydrogen, comprising:
a storage component; and
a hydrogen storage medium disposed within the storage component;
wherein the hydrogen storage medium comprises boron and aluminum in a molar ratio equal to or greater than 4, and up to 10 mole percent of a catalyst or a mixture of catalysts; wherein upon exposure to certain temperatures and pressures, the hydrogen storage medium reacts with the hydrogen to form an aluminoborane hydride AlBₓHₙ wherein x is equal to or greater than 4 and n is equal to or greater than 10.

20. A method for storing and retrieving hydrogen, comprising:
providing a source of hydrogen;
providing a storage component adapted to receive hydrogen from the source, the component comprising a hydrogen storage medium, wherein the hydrogen storage medium comprises boron and aluminum in a molar ratio equal to or greater than 4 and at least one catalyst; and
exposing the medium to hydrogen from the source.

21. The method of claim 19, wherein the hydrogen storage medium comprises an aluminoborane hydride AlBₓHₙ wherein x is equal to or greater than 4 and n is equal to or greater than 10.

22. The method of claim 19, wherein the catalyst is selected from the group consisting of hydrides, fluorides, chlorides, oxides, elements and alloys and combinations thereof.

23. A fuel cell system comprising:
a hydrogen storage system for storing and releasing hydrogen;
a fuel cell in fluid communication with the hydrogen storage system for receiving released hydrogen from the hydrogen storage system and for electrochemically reacting the hydrogen with an oxidant to produce electricity and an anode exhaust; and
a catalytic combustor in fluid communication with the fuel cell for receiving the anode exhaust and for catalytically reacting the anode exhaust to produce an offgas having an elevated temperature that is greater than the temperature of the anode exhaust;
wherein the heat from the offgas is used to release the hydrogen from the hydrogen storage system and said hydrogen storage system comprises a hydrogen storage material comprising an aluminoborane hydride AlBₓHₙ where x is equal to or greater than 4 and n is equal to or greater than 10.

24. A hydrogen storage material comprising an aluminoborane hydride AlBₓHₙ wherein x is equal to or greater than 4 and n is equal to or greater than 10 and at least one catalyst.

25. The material of claim 23, wherein aluminoborane hydride AlBₓHₙ consists of AlB₄H₁₁, AlB₅H₁₂, AlB₅H₁₆, AlB₆H₁₃, AlB₇H₂₀, AlB₉H₂₄, and combinations thereof.

26. The material of claim 23, wherein aluminoborane hydride is AlB₄H₁₁ with an amorphous structure and with the following principal infrared absorption bands (in cm⁻¹): 2530 (vs), 2458 (s), 2380 (s), 2350 (s), 2275 (vs), 2100 (m), 2050 (m), 1150 (m), 1050 (w), 990 (m), 935 (m), 910 (m), 850 (w), and 800 (w).

27. The material of claim 23, wherein the aluminoborane hydride is AlB₅H₁₂ with an amorphous structure and with the following principal infrared absorption bands (in cm⁻¹): 2530 (s), 2460 (s), 2350 (m), 2270 (m), 2090 (m), 2030 (m), 1148 (m), 1040 (w), 990 (m), 900 (w), 850 (w), and 800 (w).

28. The material of claim 23, wherein the aluminoborane hydride is AlB₆H₁₃ with an amorphous structure and with the following principal infrared absorption bands (in cm⁻¹): 2520 (s), 2450 (w), 2370 (m), 2355 (m), 2260 (s), 2100 (m), 1145 (m), 1040 (w), 970 (m), 925 (m), 910 (w), and 840 (w).

29. The material of claim 23, wherein the catalyst is selected from hydrides, fluorides, chlorides, oxides, elements and alloys and combination thereof.

30. The material of claim 23, wherein the catalyst is present in an amount between about 0.1 mole percent to about 10 mole percent.

31. The material of claim 23 further comprising a dopant in the aluminoborane hydride AlBₓHₙ to replace Al.

32. The material of claim 26, wherein the dopant is selected from elements such as titanium, vanadium, chromium, zirconium, niobium, yttrium, lanthanum, manganese, nickel, iron, cobalt, silicon, copper, zinc and combinations thereof.

33. The material of claim 26, wherein the dopant is present in an amount up to about 20 mole percent to replace Al in aluminoborane hydride AlBₓHₙ.

34. A material comprising:
boron and aluminum in a molar ratio equal to or greater than 4; and, about 0.1 mole percent to 20 mole percent of a catalyst.

35. The material of claim 29, wherein the boron is amorphous.

36. The material of claim 29, wherein the catalyst is selected from hydrides, fluorides, chlorides, oxides, elements and alloys and combination thereof.

37. The material of claim 29, wherein the catalyst comprises:
a hydride selected from NaH, LiH, and NaAlH₄; and
a chloride selected from TiCl₃, ZrCl₄, and RuCl₃ or a fluoride selected from TiF₃, ZrF₄, and RuF₃.
